(19) United States
(12) Patent Application Publication
(10) Pub. No.: US 2026/0292455 A1
(43) Pub. Date: Sep. 24, 2026

(54) ENHANCED TELEMATICS CONTROL UNIT FOR CONTINUOUS VEHICLE CONNECTIVITY

(71) Applicant: Charter Communications Operating, LLC, St. Louis, MO (US)

(72) Inventors: Rohith Kumar Punithavel, Englewood, CO (US); Victor Hugo Lopez Chalacan, Castle Rock, CO (US); Hossam Hmimy, Aurora, CO (US)

(73) Assignee: Charter Communications Operating, LLC, St. Louis, MO (US)

(21) Appl. No.: 19/083,778

(22) Filed: Mar. 19, 2025

(51) Int. Cl. H04W 4/40; H04W 28/02

(52) U.S. Cl. CPC H04W 4/40; H04W 28/0221

(57) ABSTRACT

The telematics control unit (TCU) of a vehicle having at least first and second wireless modems determines whether to use the first or the second wireless modem for data transfer between the vehicle and outside world. In some embodiments, the TCU is powered by an auxiliary battery when the vehicle is off, where the ML-based modem selection takes into account available power in the auxiliary battery and expected power usage for the data transfer by the different modems. If the current available battery power is too low or the expected power usage is too great, then the TCU will reject the data transfer.

### BACKGROUND

### Field of the Disclosure

The present disclosure relates to telematics control units for automobiles and other vehicles.

### Description of the Related Art

This section introduces aspects that may help facilitate a better understanding of the disclosure. Accordingly, the statements of this section are to be read in this light and are not to be understood as admissions about what is prior art or what is not prior art.

Modern cars are packed with sensors and modules such as cameras, radar, lidar, communication devices, etc. These sensors generate vast amounts of data, and the collected data carries information on the road environment, vehicle performance, driver behavior, location, and other real-time scenarios. This data is uploaded with the help of wireless networks such as Wi-Fi, LTE, 5G, etc. The uploaded data is then used in applications around the vehicle ecosystem for predictive maintenance, autonomous driving development, traffic and fleet management, improvised personalized experience, etc. With the help of collected data, auto OEMs send software updates to improve or fix issues.

Software is revolutionizing the automotive industry, transforming vehicles into intelligent, connected, high-performance, and safe modes of transport. Software plays a pivotal role in managing vehicle functionality and introducing new capabilities. From controlling modules and sensors to enabling connectivity, entertainment, battery management, safety enhancements, autonomous driving development, and mobility solutions, software is at the core of this transformation.

Modern vehicles rely on a network of sensors and modules that generate vast amounts of data in a very short time. This data is critical for software development, as it provides real-world insights into how vehicles are used, how they perform under different conditions, and how drivers interact with onboard systems. Such insights are essential for improving vehicle performance, adding new functionalities, enabling predictive maintenance, and offering personalized enhancements. However, processing this data presents significant challenges. The sheer volume of data requires a robust system capable of managing data transfer in real time. Low latency is crucial, which means that the processing often cannot rely on cloud or edge systems. Instead, onboard systems handle much of this task, which demands considerable power and affects the health of the vehicle's battery. A vehicle's battery is used to power all onboard units, and its operation outside of driving can drain the battery quickly.

The onboard system processes data for uploading. Data uploading in automotive situations is transferring data generated by the vehicle to an external destination. Thus, data uploading in vehicles while the engine is off (and the battery is not being charged) is a critical consideration, especially for connected cars and electric vehicles. Data uploading supports numerous advancements, including predictive maintenance, analytics, traffic and fleet management, and personalized user experiences. By uploading data efficiently, automotive manufacturers can ensure smarter, safer, and more efficient vehicles. In essence, data uploading and robust software systems are shaping the future of the automotive industry, driving innovation and redefining the way we interact with cars.

A Telematics Control Unit (TCU) module is a small computer in a vehicle that manages communication between the vehicle and the outside world. The TCU in a vehicle supports emergency call system, data upload, and over-the-air updates. Data generated by sensors and other modules inside the vehicle is sent to the TCU module, and then the data is transferred to the external destination from the vehicle. The car's battery often challenges the TCU module's operation to upload or download data in a parked vehicle when the engine is off. The car battery is essential as it provides power to start the car but draining it for TCU-related tasks is not essential. Hence, typically, in parked cars, there is no data upload or download.

### SUMMARY

Problems in the prior art are addressed in accordance with the principles of the present disclosure by a custom software module that functions as a battery management system, implemented on the TCU module in the vehicle, and an auxiliary battery to support TCU operation, where the battery management system controls the discharge rate of the auxiliary battery.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified block diagram representing an enhanced Telematics Control Unit (TCU) of the present disclosure;

FIG. 2 is a process flow diagram representing the operations of the TCU of FIG. 1;

FIG. 3 is a workflow diagram of the processing of steps 204 and 206 of FIG. 2 by the TCU of FIG. 1 for a data upload; and

FIG. 4 is a workflow diagram of the processing of steps 204 and 206 of FIG. 2 by the TCU of FIG. 1 for a data download.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

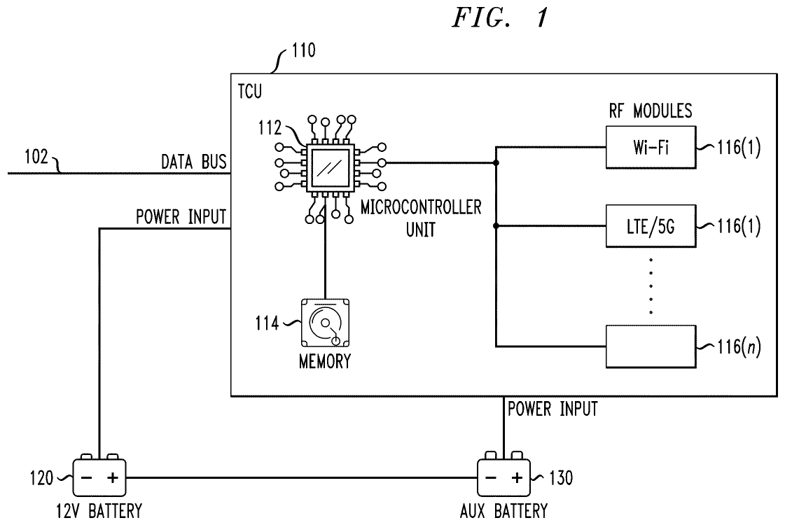

FIG. 1 is a simplified block diagram representing an enhanced Telematics Control Unit (TCU) 110 of the present disclosure connected to both the main battery 120 and an auxiliary battery 130 in a vehicle (not shown), such as an automobile or truck. As shown in FIG. 1, the TCU 110 comprises a microcontroller 112, memory 114, and a number of different wireless modems 116, such as a Wi-Fi modem 116(1) and an LTE/5G modem 116(2). In addition or instead, wireless modems 116 may be suitable Bluetooth, DSRC RF circuit, GPS, etc., modems.

In certain embodiments, the microcontroller 112 runs an RTOS/Linux/Automotive operating system based on the vehicle OEM's preference, and the auxiliary battery 130 is compact and rated at 12V 40000 mAh, similar to laptop batteries. The auxiliary battery 130 is sufficient to power the TCU 110 and other components in the vehicle, if required. The microcontroller 112 also hosts a battery management system to control the discharge rate in the auxiliary battery 130. The battery management system monitors and controls charge/discharge cycles, protects against over-discharge, adjusts discharge rates based on usage patterns, and puts the system into a low-power state (sleep mode) during which the TCU 110 draws minimal current from the auxiliary battery 130.

In one possible mode of operation, the TCU 110 is powered by the main battery 120 when the vehicle is on and by the auxiliary battery 130 when the vehicle is off. Note that, when the vehicle is on, the auxiliary battery 130 is recharged. The TCU 110 is connected to a data bus 102 that transfers data between the microcontroller 112 and other electrical components (not shown) within the vehicle, such as sensors and other processors.

In addition to its other, conventional TCU functions, the microcontroller 112 runs a custom software module that determines which modem 116 to use to upload outgoing data to the outside world and/or to download incoming data from the outside world, assuming that different modem options are available. Unless explicitly described otherwise, the functionality of the microcontroller 112 described herein refers to the functionality of that custom software module run by the microcontroller 112.

The microcontroller 112 monitors and controls battery parameters, like adjusting auxiliary battery discharge patterns based on usage. The auxiliary battery's depth of discharge (DoD) is configurable as per OEM's requirement and, for example, if DoD is set at 85-15, then 85% of capacity will be used and the remaining 15% is kept as reserve. The microcontroller 112 will look for data upload or download requests on the TCU 110, allow the TCU 110 to be powered by the auxiliary battery 130, and check and perform a smart action validation based on data throughput, tonnage, RF module's unit power, auxiliary battery's charge, and other external factors like temperature, etc. Also, the microcontroller 112 will check if an alternative, high-throughput network connectivity option is present, in which case, the microcontroller 112 will control the modem in the TCU 110 to switch to the alternative network after checking and validating the performance.

The TCU 110 uses machine learning (ML) to predict and estimate values and thresholds by analyzing real-time data to adapt to evolving patterns and trends in the current working environment.

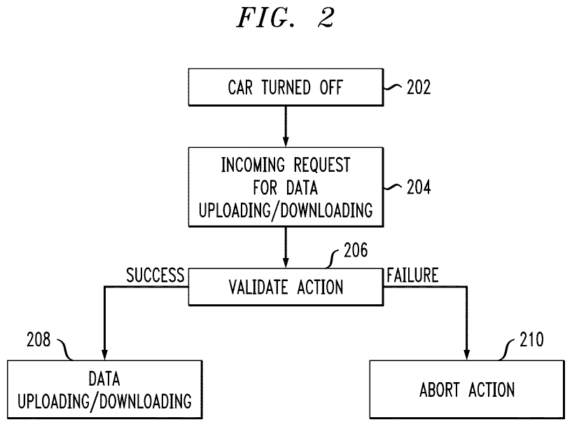

FIG. 2 is a process flow diagram representing the operations of the TCU 110 of FIG. 1. In step 202, the TCU 110 determines that the vehicle is turned off and switches from being powered by the main battery 120 to being powered by the auxiliary battery 130. In some implementations, the TCU 110 receive data signals from other components in the vehicle through data bus 102 of FIG. 1. With the help of the ignition signal transmitted through the data bus 102, the TCU 110 can determine if the vehicle is turned on or not. A power management/power switching module (not shown) with relays helps the TCU 110 to switch batteries and draw power as needed. Note that, when the vehicle is turned on again, the TCU 110 will again be powered by the main battery 120.

In step 204, the TCU 110 receives a request for either data uploading (from internal components in the vehicle) or data downloading (from the outside world via the currently selected modem 116).

In step 206, the TCU 110 determines whether or not to grant the request by validating the requested upload/download action and battery management. The incoming request for either data uploading or data downloading is validated against attributing factors like current auxiliary battery charge, data throughput, total data tonnage, RF module's unit power, and other external factors like temperature, etc. The TCU 110 uses Machine Learning (ML) to assist in decision making.

If the request is successfully validated in step 206, then, in step 208, the data is uploaded/downloaded; otherwise, in step 210, the requested action is aborted.

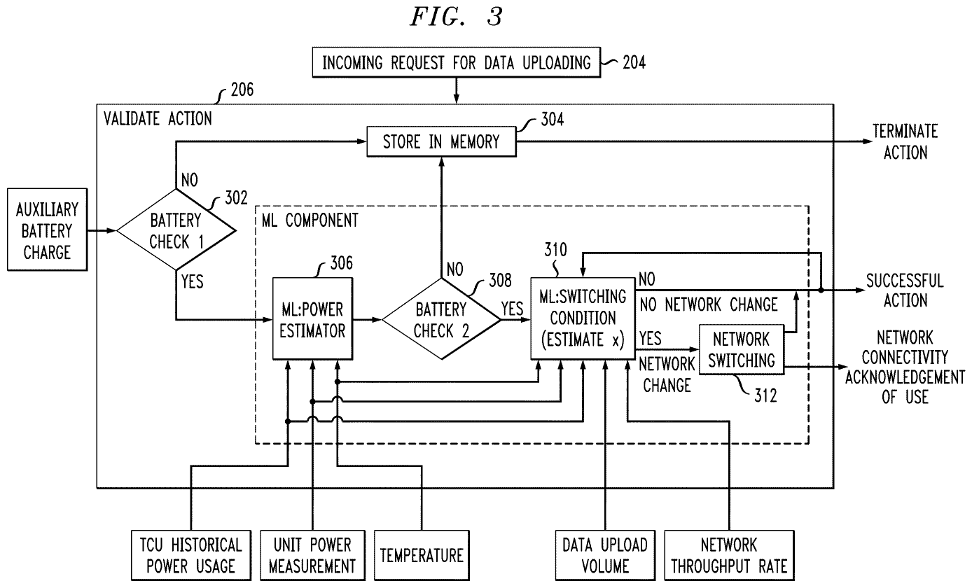

FIG. 3 is a workflow diagram of the processing of steps 204 and 206 of FIG. 2 by the TCU 110 of FIG. 1 for a data upload. In step 204, the TCU 110 receives the incoming request for data uploading of available outgoing data.

In step 302, the TCU 110 compares the current auxiliary battery charge level (e.g., percentage of total charge) to a configurable DoD threshold set by the vehicle OEM. If the current auxiliary battery charge level does not exceed the set threshold, then the TCU 110 determines that there is insufficient charge in the auxiliary battery 130 for the requested data uploading operation. In that case, in step 304, the TCU 110 stores the available outgoing data in the memory 114 (for subsequent uploading, for example, when the vehicle is turned on again) and terminates the operation. Otherwise, processing proceeds to step 306.

In step 306, the TCU 110 uses input data, such as the data upload volume, the network throughput rate, the historical TCU energy usage, the RF module unit power consumption, and other external factors like temperature to perform power estimation to predict the new unit power to be consumed for the requested data upload. The power rating of hardware components can vary based on external factors (e.g., temperature, voltage fluctuations, etc.). The TCU 110 will estimate an accurate and dynamic value for unit power consumption in different RF modules (i.e., modems 116 of FIG. 1) based on historical TCU energy consumption and external factors such as temperature. This estimated unit power consumption is used along with network throughput rates and data volume to calculate the estimated total energy consumption for the requested data upload.

The TCU 110 predicts unit power consumption of RF modules (e.g., Wi-Fi and LTE modems 116(1) and 116(2)) for given input features, such as:
p_{Wi-Fi} and p_{LTE} are unit power consumption of the Wi-Fi and LTE modems 116(1) and 116(2), respectively;
Pₕᵢₛₜ is the historical energy consumed by the TCU 110 for individual Wi-Fi and LTE communications; and
temp is current external temperature measured by the vehicle.

The output variables \hat{p}_{Wi-Fi} and \hat{p}_{LTE} are the predicted unit power consumptions of the Wi-Fi and LTE modems 116(1) and 116(2) for the given external conditions of the vehicle.

The generalized (Wi-Fi and LTE) Machine Learning model function ƒ, which may be implemented using linear or non-linear neural networks, is given by:

$$\hat{p} = f ( {P}_{hist} , p , temp ; θ )$$

where θ are the parameters of the model learned during training.

The model is trained with data gathered from vehicles, which are first preprocessed to ensure consistency and quality. A loss function (for example, mean squared error) is defined. During training, this loss function is minimized with optimization techniques (for example, gradient descent). After training, the model is evaluated with performance metrics (for example, root mean squared error) to evaluate and ensure its reliability. The unit power of the module is used to calculate total energy usage/battery percentage required to perform the upload/download data.

In step 308, the TCU 110 performs a battery check to determine if the auxiliary battery charge will be within the acceptable threshold after the requested data upload is performed. In particular, the battery consumption is calculated from the estimated total energy consumption. The battery consumption is subtracted from the current charge percentage, and the remaining battery percentage is checked to see if it will be above the threshold level. In particular:

$$Estimated Battery Usage = Estimated Unit Power Consumption * Estimated Total Time Taken$$

$$Estimated Remaining Battery Usage = Current Auxilary Battery Charge - Estimated Battery Usage$$

$$Estimated Remaining Battery Charge = Threshold Auxiliary Batttery Charge$$

If not, then, in step 304, the data is stored in the memory 114 and the data upload action is terminated, as before. If there is sufficient auxiliary battery charge, the processing flows to step 310.

In step 310, the TCU 110 determines whether to change, in step 312, the current selection of which wireless modem 116 of FIG. 1 to use for the data upload operation based on input features. The estimated power values and the predicted switching threshold form the network switching condition between different available network connectivity options. Also, during this stage, the TCU 110 checks at configurable periodic intervals to see if a better network connectivity option is available for switching.

In general, the TCU 110 weighs the advantages and disadvantages of the different available wireless transmission options in determining which option to select at a given time based on the situation at that time. For example, one option may provide advantages such as higher bandwidth and lower latency than another option but at the disadvantage of requiring more power.

The switching decision for a given data volume between available network options is based on a threshold value estimated by ML training. This estimated dynamic threshold value helps decide which network option suits the best and offers lower battery consumption. Let, p_{Wi-Fi} and p_{LTE} be the unit power consumed for the Wi-Fi and LTE modems 116(1) and 116(2) in the vehicle;
p_{Wi-Fi} and p_{LTE} be the total energy consumed by the Wi-Fi and LTE modems in the vehicle for the data upload/download action;
T_{Wi-Fi} and T_{LTE} be the time taken by the Wi-Fi and LTE modems in the vehicle for the data upload/download action;
Th_{Wi-Fi} and Th_{LTE} be the instantaneous data throughput rates for the Wi-Fi and LTE modems in the vehicle for the data upload/download action;
V_{Wi-Fi} and V_{LTE} be the data volumes requested to the Wi-Fi and LTE modems in the vehicle for the data upload/download action, where the values are equal for a given task, i.e., V_{Wi-Fi}=V_{LTE}.

The problem is defined based on the switching condition in which the RF module 116 with the lower energy consumption is selected taking into consideration the variable network parameters, historical usage, and operating conditions of RF modules. For example, switch to the LTE modem 116(2) if:

$${P}_{LTE} < {P}_{Wi - Fi} ,$$

where

$${P}_{LTE} < {P}_{Wi - Fi} * x ,$$

where x is a variable factor which will change depending on other input features and (0<<<1).

For this ML module, the factor x can be predicted based on the previous input features and the input features p_{Wi-Fi}, p_{LTE}, T_{Wi-Fi}, T_{LTE}, Th_{Wi-Fi}, Th_{LTE}, V_{Wi-Fi}, V_{LTE}, Pₕᵢₛₜ, and temp, where p_{Wi-Fi} and p_{LTE} are estimated from \hat{p}_{Wi-Fi} and \hat{p}_{LTE} from the power estimation of step 306. The output variable \hat{x} acts as a threshold condition for switching between available network options.

The machine learning model function ƒ is given by:

$$\hat{x} = f ( {P}_{hist} , {p}_{Wi - Fi} , {p}_{LTE} , {Th}_{Wi - Fi} , {Th}_{LTE} , {V}_{Wi - Fi} , {V}_{LTE} , temp , θ ) ,$$

where θ are the parameters of the model learned during training. The ML model function ƒ can be linear or non-linear (neural networks).

The model is trained with data gathered from vehicles, which data is first preprocessed to ensure consistency and quality. A loss function (for example, mean squared error) is defined. During training, this loss function is minimized with optimization techniques (for example, gradient descent). After training, the model is evaluated with performance metrics (for example, root mean squared error) to evaluate and ensure its reliability. The estimated x will act as the switching condition threshold between Wi-Fi and LTE.

From assumption—switch to the LTE modem 116(2) if it has lower energy consumption,

$${P}_{LTE} < {P}_{Wi - Fi} ,$$

where

$${P}_{LTE} < {P}_{Wi - Fi} * x ,$$

Writing the assumption as inequality condition:

$$\frac{{P}_{LTE}}{{P}_{Wi - Fi}} < x$$

The total energy of the LTE modem 116(2) is given by:

$${P}_{LTE} = power consumed * time taken$$

$${P}_{LTE} = {p}_{LTE} * {T}_{LTE}$$

Total time taken by the LTE modem 116(2) is given by:

$${T}_{LTE} = \frac{Total Volume}{Throughput Rate}$$

$${T}_{LTE} = \frac{{V}_{LTE}}{{Th}_{LTE}}$$

The total energy of the Wi-Fi modem 116(1) is given by:

$${P}_{Wi - Fi} = power consumed * time taken$$

$${P}_{Wi - Fi} = {p}_{Wi - Fi} * {T}_{Wi - Fi}$$

Total time taken by the Wi-Fi modem 116(1) is given by:

$${T}_{Wi - Fi} = \frac{Total Volume}{Throughput Rate}$$

$${T}_{Wi - Fi} = \frac{{V}_{Wi - Fi}}{{Th}_{Wi - Fi}}$$

Plugging values into the inequality condition yields:

$$\frac{{p}_{LTE} * \frac{{V}_{LTE}}{{Th}_{LTE}}}{{p}_{Wi - Fi} = \frac{{V}_{Wi - Fi}}{{Th}_{Wi - Fi}}} < x$$

Since V_{LTE}=V_{Wi-Fi}, the switching condition for LTE is:

$$\frac{{Th}_{LTE}}{{Th}_{Wi - Fi}} > \frac{{p}_{LTE}}{x * {p}_{Wi - Fi}}$$

and the switching condition for Wi-Fi is:

$$\frac{{Th}_{LTE}}{{Th}_{Wi - Fi}} > \frac{{p}_{LTE}}{x * {p}_{Wi - Fi}}$$

where the right-hand sides of the two inequalities are weighted ratios (due to the factor x). As understood by those skilled in the art, an appropriately sized hysteresis value can be incorporated into one of the two previous condition to prevent chattering between the LTE and Wi-Fi selections.

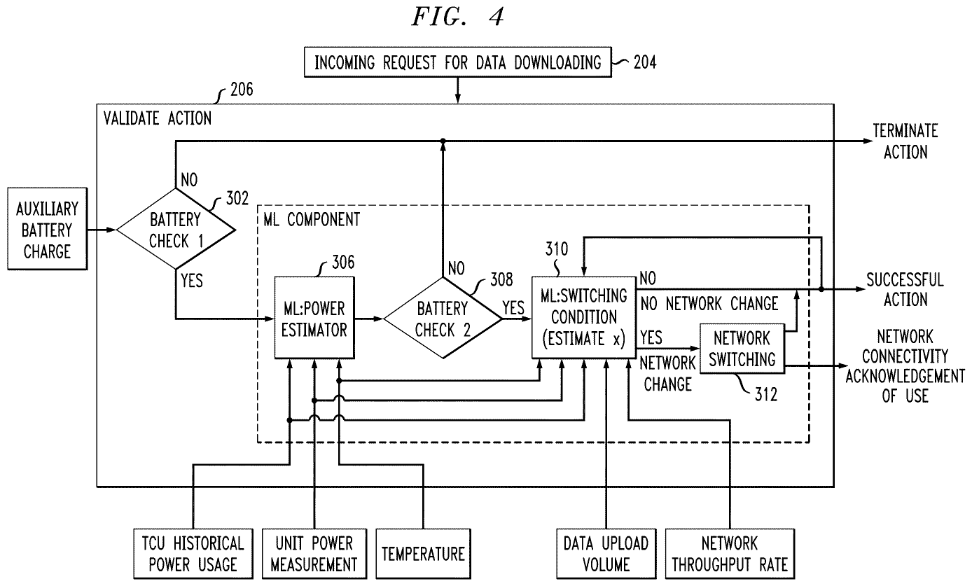

FIG. 4 is a workflow diagram of the processing of steps 204 and 206 of FIG. 2 by the TCU 110 of FIG. 1 for a data download. The processing associated with data downloading is similar to the processing associated with data uploading of FIG. 3 with the following exceptions:
Instead of receiving an incoming request for data uploading in step 204 of FIG. 3, step 204 of FIG. 4 involves receiving an incoming request for data downloading from the outside world via the currently selected modem 116 of FIG. 1;
In addition to the currently selected modem 116, the TCU 110 determines whether the outside world is currently able to transmit the incoming data using any of the other modems 116 that are available at the TCU 110. In certain implementations, this may be accomplished by the TCU 110 querying the outside world via the currently selected modem 116 or via satellite communications; and
If the requested data download is rejected in step 302 or step 308, then the TCU 110 sends a negative acknowledgement (NACK) message to the outside world. Note that, in this situation, there is no data to be stored at the TCU 110, and step 304 of FIG. 3 is omitted.

The proposed solution is helpful for continuous data uploading in vehicles for real-time communication for event-based data collection (e.g., accident scenarios), vehicle information and management, and remote diagnostics. It provides enhanced security by allowing vehicles to provide real-time alerts to owners, make emergency SOS calls, and provide roadside assistance in emergencies. The proposed solution will offer improved power management for the TCU module in the vehicle.

Although the disclosure has been described in the context of a TCU module managing power usage from an auxiliary battery in a vehicle, the disclosure can also be applied in the context of a TCU module managing power usage from a vehicle's main battery with or without an auxiliary battery in the vehicle.

In certain embodiments, the present disclosure is an apparatus comprising a telematics control unit (TCU) for a vehicle, the TCU comprising a microcontroller connected to memory and to at least first and second wireless modems. The TCU is connectable to be powered by a battery of the vehicle, and the TCU is configured to determine whether to use the first or the second wireless modem for data transfer between the vehicle and outside world.

In at least some of the above embodiments, the apparatus is the TCU.

In at least some of the above embodiments, the apparatus is the vehicle.

In at least some of the above embodiments, the vehicle comprises a main battery that powers the TCU when the vehicle is on and an auxiliary battery that powers the TCU when the vehicle is off; and the TCU is configured to determine whether to use the first or the second wireless modem for data transfer between the vehicle and outside world when the vehicle is off and the TCU is powered by the auxiliary battery.

In at least some of the above embodiments, the TCU is configured to reject the data transfer upon determining that a current charge level of the battery is below a specified threshold level.

In at least some of the above embodiments, the TCU is configured to estimate an amount of battery charge for the data transfer; and reject the data transfer upon determining that the amount of battery charge for the data transfer will result in a subsequent charge level of the battery being below a specified threshold level.

In at least some of the above embodiments, the TCU is configured to independently estimate a corresponding amount of battery charge for the data transfer for each of two or more different wireless modems; and independently determine whether each corresponding amount of battery charge for the data transfer for each different wireless modem will result in a corresponding subsequent charge level of the battery being below the specified threshold level.

In at least some of the above embodiments, the TCU is configured to determine whether to switch from a currently selected wireless modem to an other wireless modem for the data transfer based on a comparison between the two wireless modems.

In at least some of the above embodiments, the comparison involves comparing (i) a ratio of instantaneous data throughput rates for the two wireless modems to (ii) a weighted ratio of unit powers consumed by the two wireless modems.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. An apparatus comprising a telematics control unit (TCU) for a vehicle, the TCU comprising a microcontroller connected to memory and to at least first and second wireless modems, wherein:
the TCU is connectable to be powered by a battery of the vehicle; and
the TCU is configured to determine whether to use the first or the second wireless modem for data transfer between the vehicle and outside world.

2. The apparatus of claim 1, wherein the apparatus is the TCU.

3. The apparatus of claim 1, wherein the apparatus is the vehicle.

4. The apparatus of claim 1, wherein:
the vehicle comprises a main battery that powers the TCU when the vehicle is on and an auxiliary battery that powers the TCU when the vehicle is off; and
the TCU is configured to determine whether to use the first or the second wireless modem for data transfer between the vehicle and outside world when the vehicle is off and the TCU is powered by the auxiliary battery.

5. The apparatus of claim 1, wherein the TCU is configured to reject the data transfer upon determining that a current charge level of the battery is below a specified threshold level.

6. The apparatus of claim 1, wherein the TCU is configured to:
estimate an amount of battery charge for the data transfer; and
reject the data transfer upon determining that the amount of battery charge for the data transfer will result in a subsequent charge level of the battery being below a specified threshold level.

7. The apparatus of claim 6, wherein the TCU is configured to:
independently estimate a corresponding amount of battery charge for the data transfer for each of two or more different wireless modems; and
independently determine whether each corresponding amount of battery charge for the data transfer for each different wireless modem will result in a corresponding subsequent charge level of the battery being below the specified threshold level.

8. The apparatus of claim 1, wherein the TCU is configured to determine whether to switch from a currently selected wireless modem to an other wireless modem for the data transfer based on a comparison between the two wireless modems.

9. The apparatus of claim 8, wherein the comparison involves comparing (i) a ratio of instantaneous data throughput rates for the two wireless modems to (ii) a weighted ratio of unit powers consumed by the two wireless modems.

10. A method for an apparatus comprising a telematics control unit (TCU) for a vehicle, the method comprising the TCU
connecting to be powered by a battery of the vehicle; and
determining whether to use a first wireless modem or a second wireless modem for data transfer between the vehicle and outside world.

11. The method of claim 10, wherein the apparatus is the TCU.

12. The method of claim 10, wherein the apparatus is the vehicle.

13. The method of claim 10, wherein:
the vehicle comprises a main battery that powers the TCU when the vehicle is on and an auxiliary battery that powers the TCU when the vehicle is off; and
the TCU determines whether to use the first or the second wireless modem for data transfer between the vehicle and outside world when the vehicle is off and the TCU is powered by the auxiliary battery.

14. The method of claim 10, wherein the TCU rejects the data transfer upon determining that a current charge level of the battery is below a specified threshold level.

15. The method of claim 10, wherein the TCU:
estimates an amount of battery charge for the data transfer; and
rejects the data transfer upon determining that the amount of battery charge for the data transfer will result in a subsequent charge level of the battery being below a specified threshold level.

16. The method of claim 15, wherein the TCU:
independently estimates a corresponding amount of battery charge for the data transfer for each of two or more different wireless modems; and
independently determines whether each corresponding amount of battery charge for the data transfer for each different wireless modem will result in a corresponding subsequent charge level of the battery being below the specified threshold level.

17. The method of claim 10, wherein the TCU determines whether to switch from a currently selected wireless modem to an other wireless modem for the data transfer based on a comparison between the two wireless modems.

18. The method of claim 17, wherein the comparison involves comparing (i) a ratio of instantaneous data throughput rates for the two wireless modems to (ii) a weighted ratio of unit powers consumed by the two wireless modems.
